(19) United States
(12) Patent Application Publication
(10) Pub. No.: US 2009/0138906 A1
(43) Pub. Date: May 28, 2009

(54) ENHANCED INTERACTIVE VIDEO SYSTEM AND METHOD

(76) Inventors: Kurt S. Eide, Seattle, WA (US); Gavin James, Seattle, WA (US)

Correspondence Address: AXIOS LAW GROUP. PLLC, 1525 4TH AVE, STE 800, SEATTLE, WA, 98101-1648, US

(21) Appl. No.: 12/197,627

(22) Filed: Aug. 25, 2008

Related U.S. Application Data
(60) Provisional application No. 60/957,993, filed on Aug. 24, 2007.

(51) Int. Cl. H04N 7/025; H04N 7/10

(52) U.S. Cl. 725/32; 705/14

(57) ABSTRACT

A method for enhanced interactive video system for integrating data for on-demand-information retrieval and internet delivery are provided herein.

### RELATED REFERENCES

This application claims priority to U.S. Provisional Application 60/957,993 filed Aug. 24, 2007. The foregoing application is hereby incorporated by reference in its entirety as if fully set forth herein.

### BACKGROUND

With current high-technology advances, the global community is rapidly adapting to more and more ways to instantly access information and visual media from anywhere, anytime. Along with a wealth of Internet data, it is now an everyday occurrence to access entertainment media through computers and wireless video-enabled devices such as iPod®s, iPhone®s, cellular phones, and PDAs. What is missing is a means to seamlessly integrate these two critical bodies of information: a way to directly link the entertainment viewing experience with on-demand access to contextually relevant information.

The dramatic growth in access to entertainment media translates to an exponential leap in exposure and viewership, yet it also introduces important and complex challenges. For the entertainment industry, this increase in access suggests more programming and revenue opportunities, which typically means more sponsor commercials. Traditionally, these advertisements have little or no relevance to the entertainment content itself, directed merely at a target demographic. But this form of marketing is at odds with what viewers are growing to want and expect. As people are quickly adapting to new opportunities for entertainment and information access, they are also barraged with information overload, and thus, growing a very real need (and demand) for uniquely personalized experiences. These viewers are indeed potential consumers, but they want the ability to choose what they're interested in buying or learning about, based on their own needs and wants, not have it dictated to them.

The fact that the entertainment industry and Internet now offer the public a seemingly endless array of choices has introduced challenging consumer behaviors as a byproduct, and these challenges demand an innovative solution. For example, having so many, in fact, too many choices has become overwhelming, leading people to make no choice at all, instead surfing from place to place with little or no attention span to really attend to anything. For content producers and sponsors, this means a substantial amount of advertising investment is being wasted. Alternatively, having so many choices has made people more discerning, paying attention only to that which is specifically relevant to their immediate goals and interests. Here again, content producers and sponsors are often missing significant monetizing opportunities by delivering advertising that may be only remotely in context with the media being viewed, and perhaps not at all relevant to a viewer's own interests and needs.

Additionally, the media-viewing public is increasingly adopting technologies such as time-shifting digital video recorders that offer commercial-free services, allowing viewers to avoid the intrusion of auto-delivered advertising. But that certainly does not mean these people have no interest in shopping. Many viewers have plenty of consumer interests, seeking out products, services, and experiences that will improve their quality of life, aid their work, support their families, and so on. How and where they purchase these things is varied, but what they choose to buy is very likely influenced or inspired by something they viewed on television or in film. But currently, these experiences are entirely separate and out of context with one another, i.e., the media viewing experience is separate from the consumer education and purchase experience. Yet as technologies and consumer demands advance, it is becoming essential to develop a means to seamlessly integrate these elements into a unified and personalized experience.

Another consideration is in personalizing the educational experience of viewing entertainment media. Currently, viewers enjoying a film, sports telecast, or favorite television show have no way to directly and immediately access information related to a specific element in that visual media. Instead, they must later search the Internet or other media sources in hopes of learning more. For users of any age, defining search queries to produce precisely relevant results (i.e., results that are contextually relevant to that person's own needs, interests, and preferences) can take considerable trial and error, and may not yield returns that satisfy the user's specific needs. Yet the information is probably available somewhere, which means there is both a need and an opportunity to create a smart and simple way to bring that information directly to the viewers, and do so in context with their media viewing experience.

Furthermore, there exists a substantial disconnect between entertainment media, educational and consumer information related to that media, and the virtually endless knowledge resources of the Internet's global community of interested viewers. The popularity of blogging, peer-to-peer networks, and media-sharing community websites demonstrates there is a vast arena of people who regularly participate in online communities to share their interests and knowledge with others. Quite often, these communities grow based on common interests in popular entertainment media, with participants sharing a wealth of information about scene and actor trivia, products, fashion, and desirable locations—yet all this valuable data remains within the confines of the community website, distinctly separate from the media viewing itself. Additionally, in these communities, participants are essentially voicing their consumer choices, indirectly telling content producers and sponsors what advertising they should be delivering—but again, this community knowledge base is distinctly separate from advertising decision-making. Hence, this current model represents a substantial loss for both sponsors and viewers as valuable resources are being wasted. An innovative approach is needed to integrate those public resources with the entertainment media, transforming the viewer experience to include personally relevant information choices, while exponentially expanding the content producer/sponsor revenue model.

For the most part, the entertainment industry has only tapped into the global Internet community to promote viewership and monetize programming based on the dictates of their advertising sponsors. However, as a revenue model, this is considerably short-sighted. Given the rapid advances of video distribution and video tagging on the Internet, there are hundreds of millions of viewers who could potentially provide data that could translate into monetizing opportunities. Currently, this type of exchange does not exist, perhaps because it is not in the interest of major corporate sponsors who dominate the advertising landscape.

Additionally, as entertainment media is copyright-protected, it is illegal for non-owners to monetize that content in any way on their own; in fact, when the content appears on public-domain websites, it is often removed just as quickly. Nevertheless, numerous web communities exist that focus on popular media topics such as celebrity fashion, with participants sharing their knowledge about designer clothing and accessories worn by actors in popular films and TV shows, and providing links to purchase points for those items. Nothing illegal is transpiring, as community members are making no money from those referrals; however, neither are the content producers or their sponsors. Instead, a random third-party business is capitalizing on some individual's knowledge about a product. This trend demonstrates there is a high demand for information and consumer opportunities related to popular entertainment media, with a focus on personalized choices. Yet there remains no direct link between this media, related product and service information, and the viewing public—largely due to the copyright restrictions and the entertainment industry's increasingly outdated advertising model.

### BRIEF DESCRIPTION OF THE DRAWINGS

FIG. 1 is a diagram of an embodiment of the client-side configuration with system design for use with a personal computer.

FIG. 2 is a diagram of an embodiment of the client-side configuration with system design for use with a personal computer, and use of Internet-hosted videos and disc-formatted videos.

FIG. 3 is a diagram of an embodiment of the client-side configuration with system design for use with wireless handheld video-enabled devices.

FIG. 4 is a diagram of an embodiment of the client-side configuration with system design for use with an Internet-enabled television set (such as IPTV or Digital TV).

FIG. 5 is a diagram of an embodiment of the server-side configuration of the system.

FIG. 6 is a diagram showing search query capabilities supported by the client and server sides of the system.

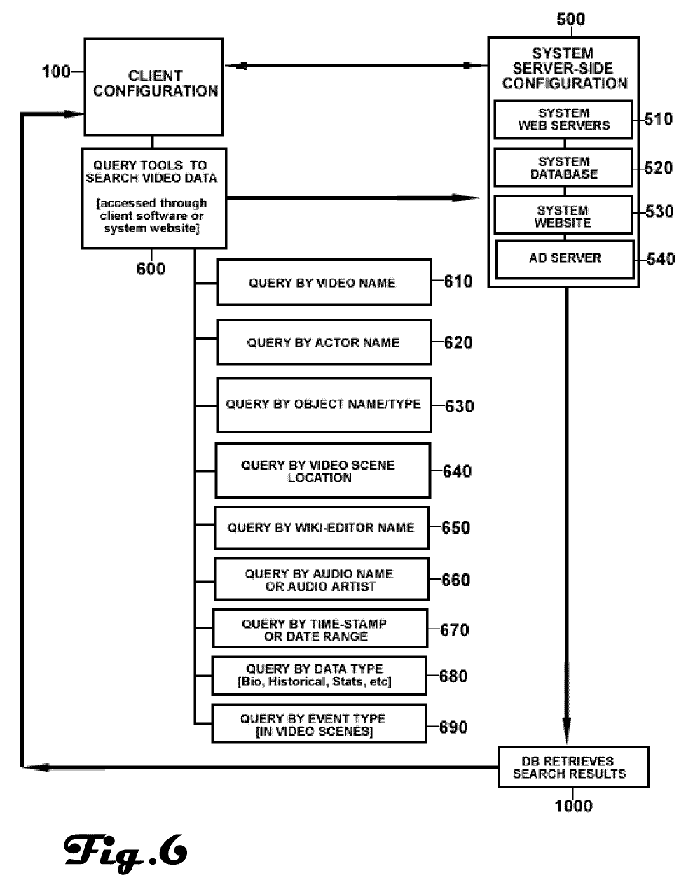

FIG. 7 is a diagram showing capabilities for user-generated content related to videos as supported by the client and server sides of the system.

FIG. 8 is a diagram showing capabilities for auto-extracted video-related metadata as supported by the server side of the system.

FIG. 9 is a diagram of an embodiment of the system showing collaborative tools available on the system website.

FIG. 10 is a diagram of an embodiment of the system database search query results as supported by the server side of the system.

FIG. 11 is a diagram showing a user interaction scenario for interacting with video to generate a search query to the system and receive information/results delivered through the system website.

FIG. 12 is a diagram of an embodiment of the system client software image tagging toolset and a scenario for encoding user-generated video still images and submission of user-generated content to the system database.

FIG. 13 is a diagram of an embodiment of the system client software image tagging toolset.

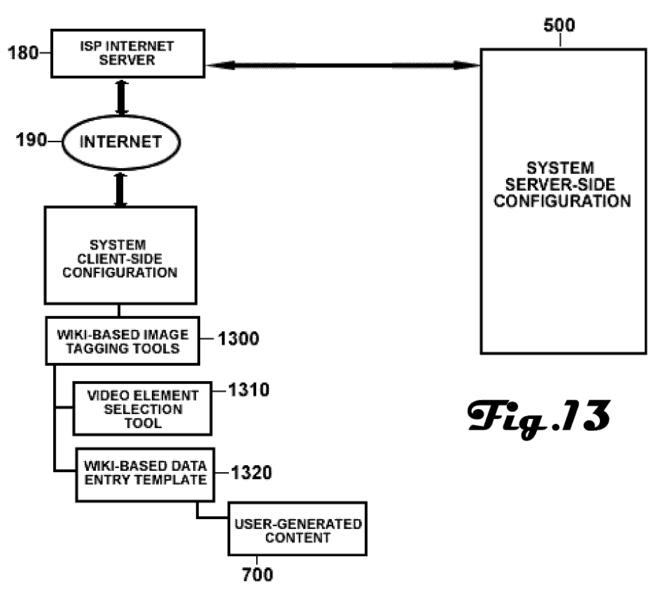

FIG. 14 is a diagram of an embodiment of the system client software video-interaction options menu, and a scenario for selecting the option to view video-related data immediately, as supported by the server-side of the system.

FIG. 15 is a diagram of an embodiment of the system client software video-interaction options menu, and a scenario for selecting the option to access video-related data later from a saved favorites list, as supported by the client and server sides of the system.

FIG. 16 is a diagram of an embodiment of the server-side of the system with the system database including a reputation engine to track performance of user (wiki-editor) contributions to the system.

### DESCRIPTION

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

A desirable part of creating a win-win solution for both the entertainment industry and the viewing public is the element of viewer choice. The system described below allows viewers to interact directly with high-interest visual media content, such as current films and popular television shows, to extract information based on elements of interest in that media. Available across multiple delivery mediums (broadcast, DVD, IPTV or other Internet-enabled television sets, Internet-hosted video, and mobile devices), this technology will provide viewers with a simple, yet sophisticated resource for accessing and sharing information about entertainment media-based on personally relevant and contextually specific choices—while, in turn, increasing opportunities for content producers to monetize that media.

Typically, with high-demand, copyright protected entertainment media, producers have relied on high profile sponsor advertising to fund their programming, yet this model carries limitations in how ads can be delivered and the likelihood they will attract buyer attention. In other words, it may be a high-risk proposition for sponsors, especially when the viewing public is increasingly resisting the intrusion of forced advertising (i.e., “Don't interrupt my experience to sell me something I don't want.”), instead demonstrating a preference for an experience of personally relevant choices, addressed at personally chosen times. This system will provide that flexibility to viewers, with on-demand access to information and consumer resources in a contextual model that also introduces a new, more comprehensive advertising paradigm for content producers and sponsors.

Through a mechanism such as plug-in software for Internet browsers, media players, or other video player devices, viewers watching entertainment on any video-enabled device could interact with that video to gain on-demand access to both educational and consumer information related to elements in a given scene, such as actor bios, scene location, fashion, decor, gadgets, and music. This data would be retrieved from the system's core component: a web server-based contextual search database of visual media metadata that delivers semantically relevant results, partnered with an ad-server engine that delivers contextual advertising.

For example, a viewer watching a television program on their computer or web-enabled Digital TV could use a pointing device (such as a mouse or remote control) to interact with the screen when they encounter elements of interest, for instance, a tropical location. Clicking the video scene would allow the viewer to immediately access related information resources such as educational facts, additional images, and hyperlinks to travel resources for visiting that location. Similarly, if the viewer were interested in the tropical apparel worn by one of the actors, they could click on the actor to retrieve information about the garments, including designers and links for purchase.

When a viewer (with the system plug-in installed) interacts with video onscreen, the system captures a still image screenshot of the current scene, and uses that image along with basic logistical metadata extracted from the video playback to comprise a copyright-independent data packet that serves as criteria to generate a search query, which is then sent from the viewer's local environment to the system's Internet-based visual media database. The system delivers search results (i.e., video-related information) back to the viewer through a destination website based on a community model designed to appeal to film and television enthusiasts. Viewers can then browse search results categorized into relevant groups based on areas of interest about that visual media, such as the actors, locations, fashion, objects, and music, and access direct purchase points for items related to that media, as well as links to advertising that is contextually relevant to that media. Viewers can also browse other entertainment interests and engage in the collaborative features of the community website.

In one embodiment, the system will support a copyright-independent model for information delivery and monetization related to entertainment media. The system may process user-generated video still images for metadata tagging purposes, and reference user-contributed still images as opposed to providing (i.e., hosting) copyright-protected video files or allowing encoding of copyright-protected video files. As the system technology progresses and gains adoption, partnerships with content producers may evolve to include more complex encoding of copyright-protected media files, as well as a broader representation of that media on the system's destination website.

One component of the system will be features that allow entertainment enthusiasts to contribute their own knowledge using tools to capture video still images and then, using a simple template, tag those images with metadata such as factual details, categorical data, and unique identifiers (such as barcodes) for products, and supplemental information such as editorial commentary. Users can also add or edit supplemental content to existing tagged images. All of this data will be stored by the system's visual media database and used to increase the accuracy and relevance of search results, as well as extending the depth and breadth of information available for any given video known to the system. The system may include an image tagging toolset on both the destination website and as part of the plug-in software to enable users to contribute to the database from within or outside the system-related website.

In addition to video still images and viewer-contributed metadata, when viewers interact with video, the system web servers will extract basic logistical data from the viewer's media player source such as the video file name, file size, duration, time-stamp of the currently selected scene, source URL of video streamed from an external location, and more. This data is sent from the viewer's local environment to the system web server database as part of the data packet that comprises search criteria.

This basic logistical metadata extracted by the system web servers will also be useful to the system's predictor engine to support information retrieval for those cases when viewers interact with media not yet known to the system. In this event, the system will reference the video's foundational metadata to retrieve results of a similar match, such as videos with a similar name, those in the same series, or media of a similar nature.

The system's destination website would also be the distribution point for the system plug-in software, requiring users to register an account. Viewers can then log-in to the system via the plug-in (or the website), which connects their local environment with the system web server database, thereby activating the interactive and information-retrieval capabilities of their video viewing experience.

Alongside search results, the system will deliver contextually relevant sponsor advertising. As relevance is typically of high importance to user adoption and purchase click-through, the system will integrate the database's visual media metadata with user account data to generate advertising that is both topically relevant and demographically relevant. User accounts with basic contact information will include the option to create customized profiles with demographic data such as age, gender, and zipcode. In this way, the system database and ad-server engine can deliver advertising more relevant to a specific viewer. For example, a 44 year old woman watching the film “Casino Royale” might respond to ads offering travel opportunities to exotic locations shown in the film, or luxury cars sold at a dealership near her home. A 17 year old boy watching that same film might respond better to ads for gadgets seen in the film or trendy apparel worn by the actors.

Another feature of the system further supports viewer choice, allowing viewers two options when they interact with video scenes: they can access information immediately or bookmark their selections to a saved list of favorites that they can access later. For saved items, the system will cache the captured video still images on the user's local device; they can later open their saved list via the plug-in software or within their account on the destination website to run searches based on those video scenes of interest.

To promote user adoption and retention, the destination website will include features that allow users to subscribe to videos or media categories of interest to them in order to receive e-mail notifications when new information becomes available. Similarly, users will be able to send referral e-mails to other people, which provide linked access to any content of interest on the destination website.

The system will support diversity across delivery mediums and devices, providing technology scenarios formatted to accommodate all video-enabled media devices such as personal computers, Internet-enabled television sets and projection systems, cellular phones, portable video-enabled media players, PDAs, and other devices. In particular, both the system software and destination website will be designed to scale appropriately for delivery across multiple platforms, while meeting industry-standard usability and accessibility requirements.

One factor in tracking video metadata employs a time-based model, whereby the system could accurately identify the context of still images based on their time placement within an overall video known by the system. Additionally, the system may eventually evolve to include more sophisticated image recognition technology to further support semantically relevant information retrieval.

Eventually, the technology may evolve to include more complex time-based encoding of video files, whereby users could identify scene elements based on the time-span in which those elements are relevant to scenes. While this in-depth model for video tagging may increase the encoding legwork for each video, it opens up many new opportunities. For the website community of “video taggers”, it could provide opportunities to earn money by being the first to tag elements in given video scenes. For users of the system-related, this advancement could deliver a greater depth and relevance in information retrieval, and higher quality of relevance in contextual advertising. Furthermore, for content producers and sponsors, this advancement could provide countless new avenues for monetization of visual media.

An additional implementation of the system may include the association of data and/or specific URLs (Uniform Resource Locators) with a grid-based system within video or television signal(s) or other recorded media. The system would capture the screen coordinates of user interaction (from a pointer device such as a mouse or touch pad) via a transparent video grid overlay, in tandem with image recognition technology, as a means to more accurately identify the precise screen element chosen by the viewer. The resulting data would be used by the system to further prioritize and fine-tune search results and information retrieval.

One goal of this system is to bring together high-demand entertainment media, information and consumer resources related to that media, and the vast viewing public—unifying all three components into a single platform that serves the needs of all the components. For the entertainment industry, the system could extend their revenue capabilities with a new, more comprehensive advertising model; for media-related information and consumer resources, the system puts this data in direct and appropriate context, improving value, meaning, and usefulness; and for the viewing public, this system delivers a solution that enhances the media viewing experience by removing commercial interruption and fragmented information resources, replacing it all with direct access to relevant information based on their own personal choices and timing.

This system integrates the vast array of Internet-based information and consumer resources with high-demand video programming (television, film, and other visual media sources) through a model of video interaction for on-demand, contextually specific information search and retrieval.

The system supports video programming created in any conventional means known in the art, and supports video in analog, digital, or digitally compressed formats (e.g., MPEG2, MPEG4, AVI, etc.) via any transmission means, including Internet server, satellite, cable, wire, or television broadcast.

This system can function with video programming delivered across all mediums that support Internet access, including (but not limited to) Internet-hosted video content 250, or disc-formatted video content 240 (preformatted media such as CD-ROM, DVD or similar media), any of which that can be viewed on an Internet-enabled computer 110, Internet-enabled television set 410 (also known as IPTV or Digital TV), Internet-enabled wireless handheld device 310, or Internet-enabled projection system.

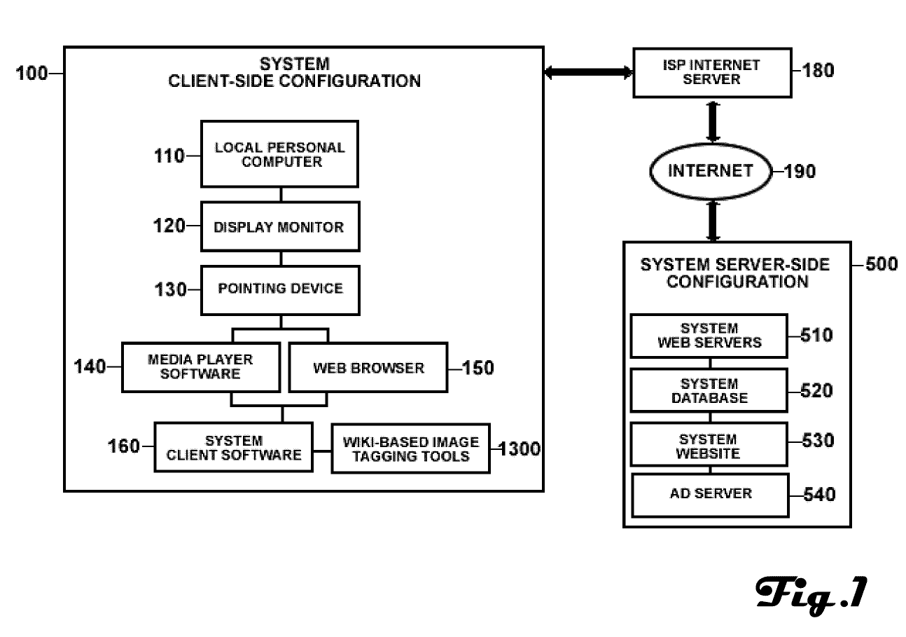

As shown in FIG. 1, one embodiment of this system shows the client-side configuration 100 whereby a user with a personal computer 110 connected to the Internet 190 through an Internet server 180 uses the system's client software application 160, which functions as a platform-independent plug-in for any digital media player software 140 or web browser 150. The client software 160 functions to connect the user's local media device with the system's Internet-based web servers 510 and visual media database 520, and the system Internet-based website 530, enabling access to the search and information retrieval functionality of the system 600, as well as enabling use of the system's wiki-based image-tagging toolset 1300.

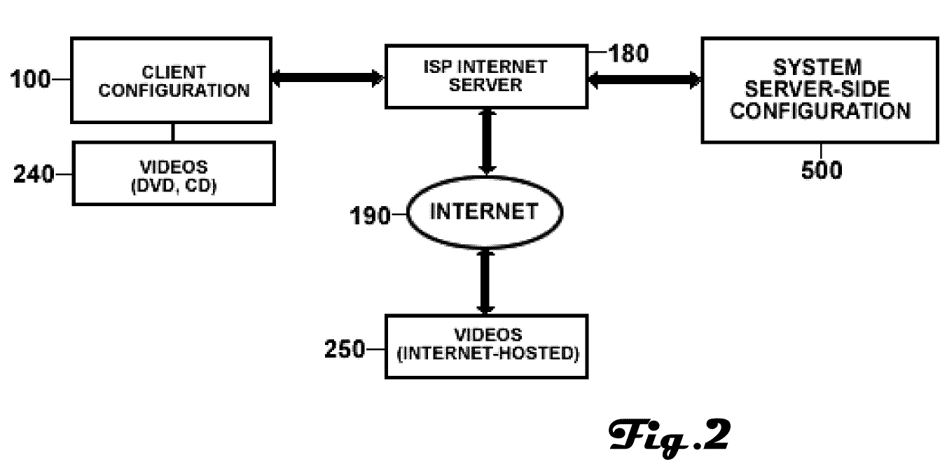

As shown in FIG. 2, an embodiment of this system shows the client-side configuration 100 whereby a user connected to the Internet 190 through an Internet server 180 would use media player software 140 to view Internet-based videos 250 or disc-formatted videos 240 (on DVD, CD-ROM or similar media). In this scenario, the user's local environment would also have the system client software 160 installed, which connects the user's local device with the system web servers 510, database 520, and website 530 for search and information retrieval. The user could then view videos 240, 250 and interact with the computer screen 120 using any standard pointing device 130 (such as mouse, stylus, laser pointer, remote control pointer, or touch control) to query the system database 520 for information related to the selected video scene; and add (user-generated) metadata and/or other content 700 related to a selected video still image screenshot 550 using the system toolset 1300.

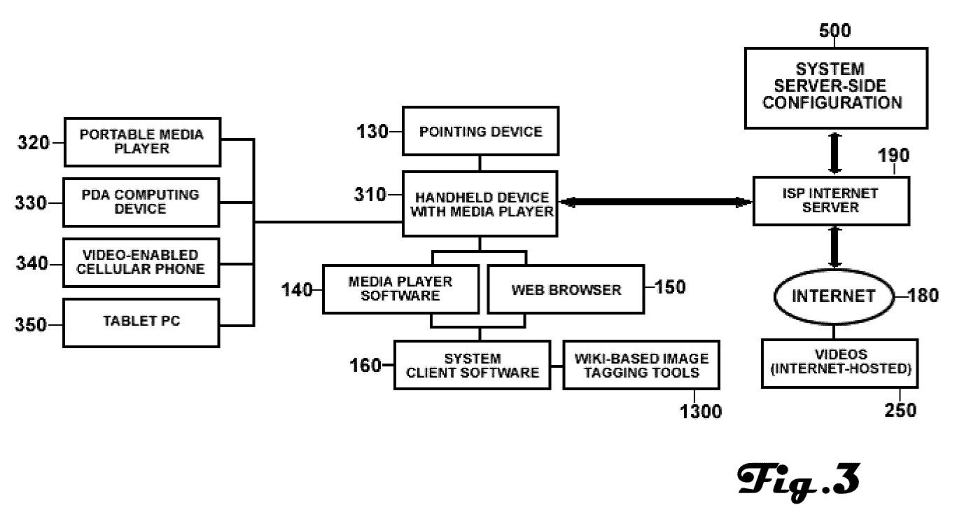

As shown in FIG. 3, another embodiment of this system shows the client-side configuration whereby a person could use a wireless handheld digital device 310 such as a portable media player 320, PDA computing device 330, video-enabled cellular phone 340, or Tablet PC 350. As with a desktop computer, the wireless handheld device would be connected to the Internet 180 through an Internet server 190 and employ media player software 140 to view Internet-hosted videos 250. The user's local environment would also have the system client software 160 installed, connecting the user's local device with the system web servers 510, database 520, and website 530 for search and information retrieval, and enabling use of the system's wiki-based toolset 1300. The user could then view videos 250 and interact with the screen using any pointing device 130 to query the system database 520 for information related to the user-generated video scene still image screenshot 550; and add metadata or other content 700 related to a selected video scene still image screenshot 550 using the system toolset 1300.

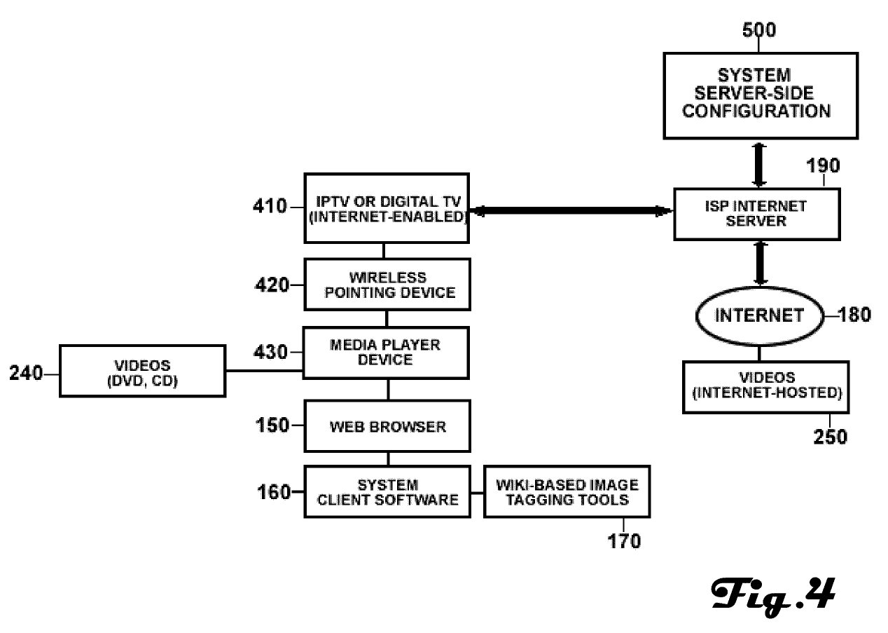

Another embodiment of the client-side configuration, as shown in FIG. 4, supports users who have an Internet-enabled television set 410 (also known as IPTV or Digital TV) to view Internet-hosted videos 250 or disc-formatted videos 240 such as DVDs, CD-ROMs or similar media using a peripheral device such as a DVD player 430. The IPTV 410 is connected to the Internet 190 through an Internet server 180, and the IPTV computing system 410 includes media player software. The IPTV 410 would support installation of the system client software 160, connecting the user's IPTV 410 with the system web servers 510, database 520, and website 530 for search and information retrieval, and enabling use of the system's wiki-based toolset 1300. The user could then view videos 240, 250 and interact with the IPTV screen 410 using a wireless pointing device 420 such as remote control to query the system database 520 for information related to the user-generated video scene still image screenshot 550; and add metadata or other content related 700 to a selected video scene still image screenshot 550 using the system toolset 1300.

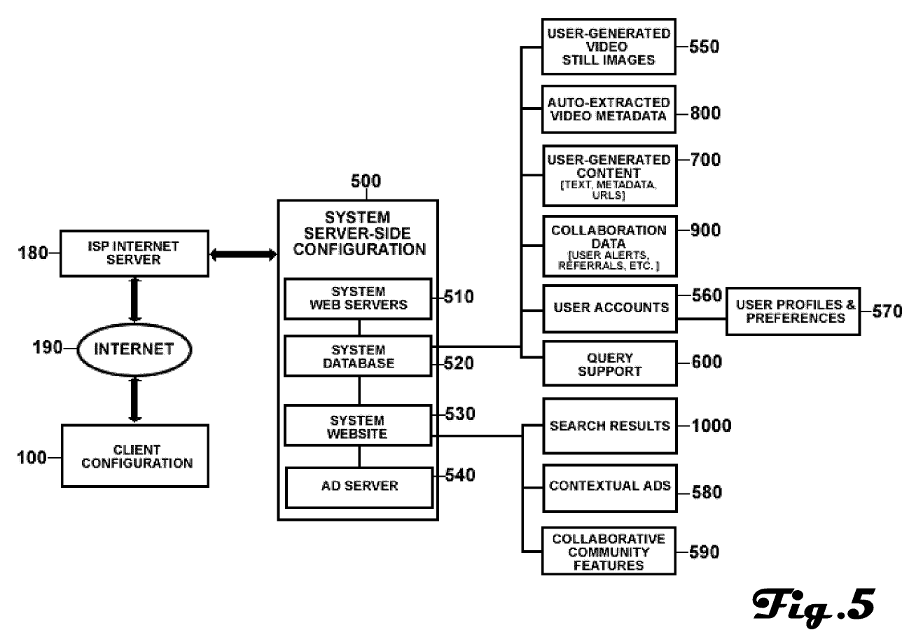

As shown in FIG. 5, an embodiment of this system shows the server-side configuration 500 whereby one or more servers 510 are connected to the Internet 190 through Internet servers 180, and employ one or more databases 520 to record, maintain, and process search and information retrieval for video-related data including user-generated video still images 550 submitted to the system; auto-extracted video metadata 800 obtained by the server from the user's local device; user-generated content 7000 related to videos; user account data 560, 570; and user collaboration-related data 900 such as referral e-mail addresses, subscription alerts/e-mail notifications, and other data that may need to be continuously tracked by the system. The system would also include an Ad Server 540 for processing, prioritizing, and delivering contextual advertising 580 alongside search results 1000.

A further embodiment of the system intends that a system-related Internet website 530 will be the distribution point for the system client software 160. In order to obtain the system client software 160, users will be required to register by setting up a user account 560 that includes an unique username and password for log-in access, and a basic profile including name and contact information including e-mail address, city, state, zipcode, and country. The system database 520 would record and maintain each user ID. The user account 560 creation process will require users to read and accept a submission agreement that outlines wiki-editing and image-tagging guidelines for submitting video still images 550 and video-related content 700 to the system. When users wish to interact with video using the system, they may be logged into the system via the client software 160 on their local media device or via the system website 530. Logging into the system connects their local environment with the system web servers 510, database 520, and system website 530, enabling access to the search and information retrieval capabilities of the system 600.

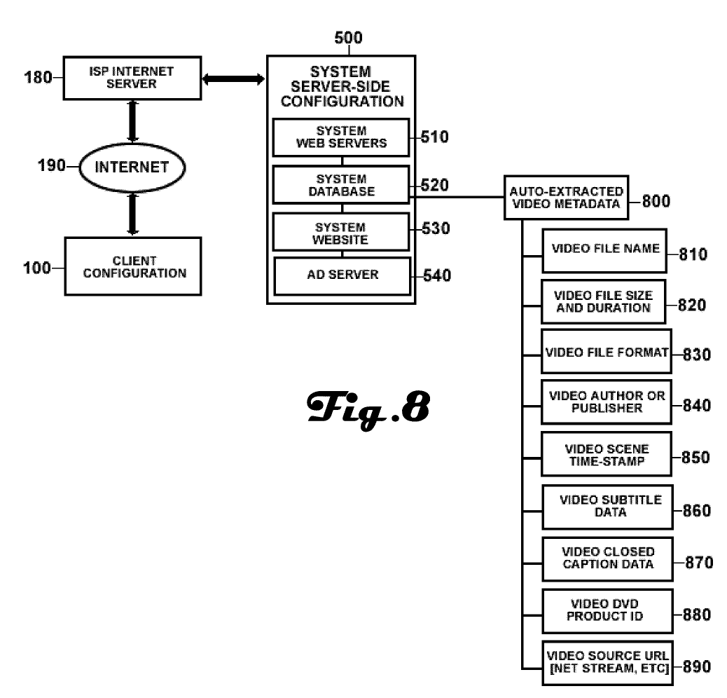

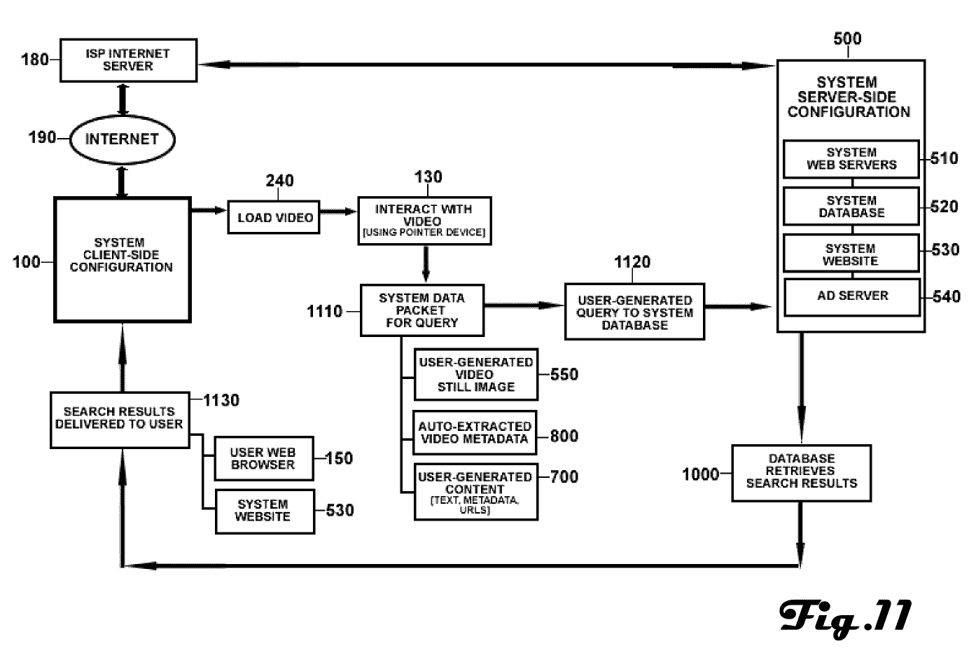

As shown in FIG. 11, when users interact with video on their local device, the system pauses video playback and captures a video still image screenshot 550 of the currently displayed video scene and caches that image on the user's local device. The system extracts that image 550 in a web-compatible format such as JPG, JPEG, GIF, BMP, PNG or other compatible format. Simultaneous to the capture of the video still image 550, the system automatically extracts any detectable video metadata 800 available through the user's local device (such as web browser, media player, video net stream, or other data source), as shown in FIG. 8. This video metadata 800 would include (but not be limited to) video file name 810; video file size and duration 820; video file format 830; video authors/publishers 840; video time-stamp 850 of the currently selected video scene; subtitle information 860 relevant to the video and the selected scene; closed captioning information 870 relevant to the video and the selected scene; DVD product identifier 880 (if applicable); and the video source URL (Uniform Source Locator) 890 of video streamed from an external location (if applicable).

The system intends that the user-generated video still image 550 would be bundled with the auto-extracted video metadata 800 to form a copyright-independent data packet 1110 that serves as search criteria for information retrieval by the system database 520, and in turn, also supports processing of contextual advertising 580 for monetizing content related to the video. This data packet 1100 is sent by the user from their local device to the system web servers 510 and database 520 to be processed for information retrieval. Search results 1000 are delivered via the system website 530 through the web browser 150 on the user's local device.

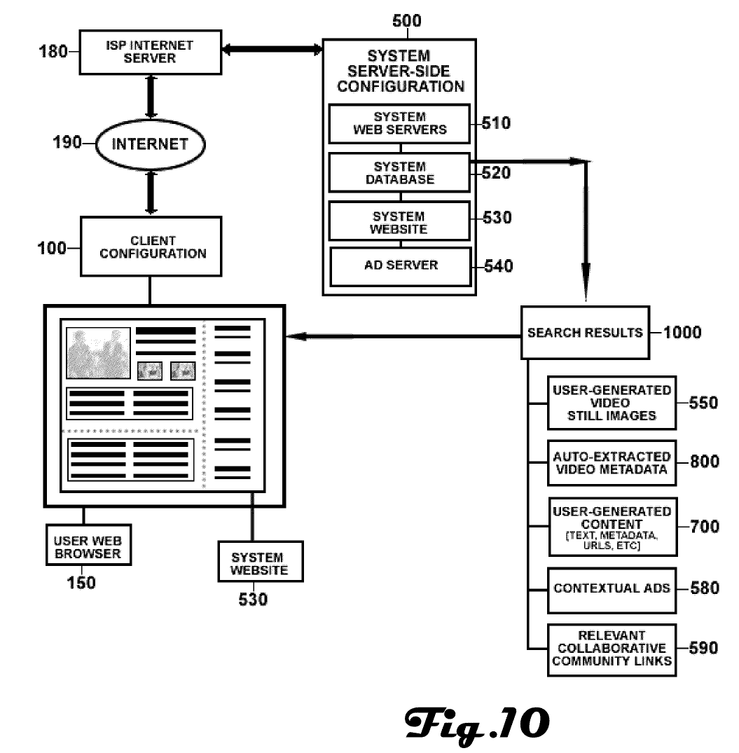

As shown in FIG. 10, an embodiment of the system's Internet website 530 delivers search results 1000 in a single page that may include (but not be limited to): the user-generated video still image screenshot 550; auto-extracted video metadata 800 identified by the system; related user-generated content 700 known to the system such as textual details, images, web community commentary, and contextually related hyperlinks; hyperlinks to collaborative community features 590 of the system website 530; contextual advertising hyperlinks 580 related to that video or the video still image 550.

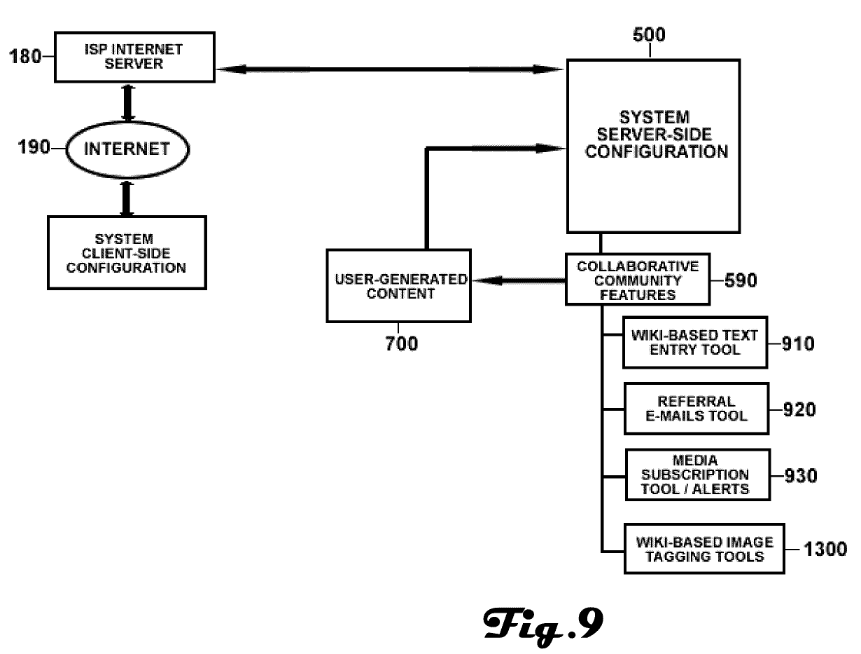

As shown in FIG. 9, another embodiment of the system website 530 will include collaborative features 590 to support community interaction, including (but not limited to): wiki-based text-entry tool 910 for creating editorial commentary related to images, video, or media-related community groups within the system website 530; subscription tool 930 for creating e-mail notification alerts to enable users to subscribe to video or community group content of interest and be notified of updates to that content; the image-tagging toolset 1300 for adding and editing data 700 to new and existing video still image screenshots 550 stored in the system visual media database 520; and a referral tool 920 that enables users to send notification e-mails regarding specific video or media-related community content from the system website 530 to other e-mail addresses internal and external to the system website 530. This tool 920 would support referral content sent via e-mail, instant messaging systems, cellular phone text messaging, SMS, and other wireless or Internet-enabled communication systems. For referring video scenes, the system would include a thumbnail version of the selected user-generated video still image 550 and a snapshot overview of the related webpage content along with a hyperlink to that webpage on the system website 530.

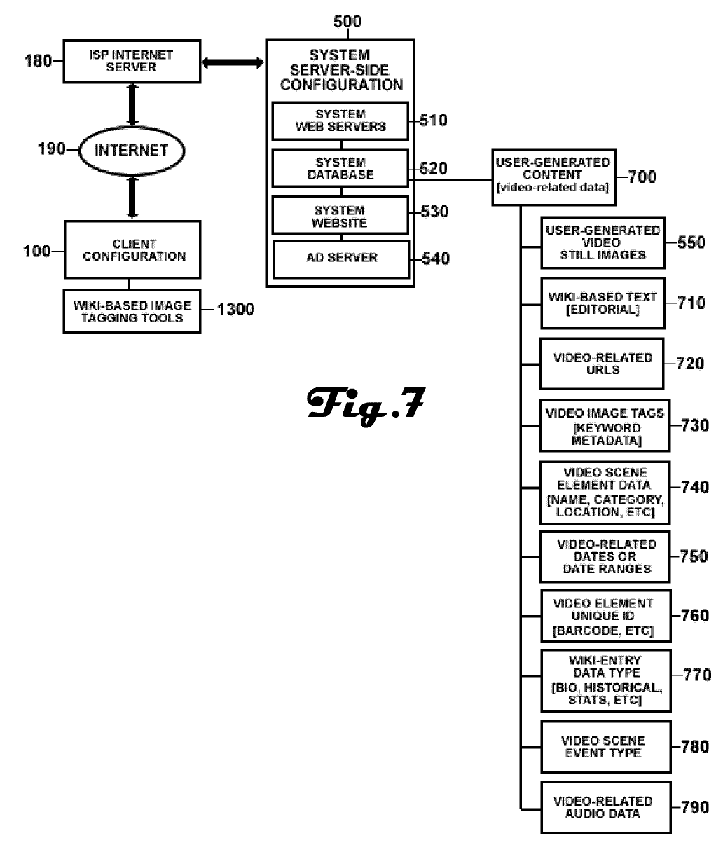

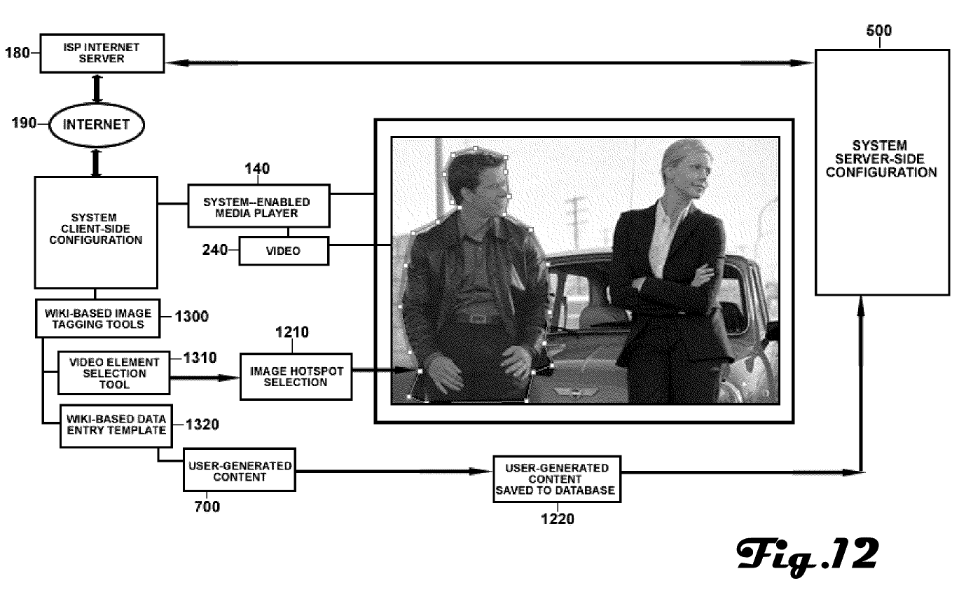

As shown in FIGS. 7 and 12, the system will support users adding supplemental data related to video still images 550 using the system's wiki-based image-tagging toolset 1300 available via the system client software 160 and on the system website 530. The system toolset 1300 would provide a wiki-based template 1320 for adding data about a video, video scene, or specific scene element related to a selected user-generated video still image 550. This supplemental data could include (but not be limited to) factual and editorial text 710 about people, places, objects, audio, and scene context represented in the selected video scene; keywords tags 730 relevant to the video still image 550; video element data 740 such as actor or object name, and/or scene location; dates or date ranges 750 relevant to the video or video scene; unique identifiers 760 (such as barcodes) for products; event types 780 to further define context for the video scene depicted in the still image 550; data related to audio 790 such as soundtrack music and artist that plays along with that video scene; and video-related hyperlinks 720 for content within the system; and reference information to related video content not yet known to the system. The data-entry template 1320 would also allow users to define categorical data 740 such as defining the scene primarily as a person, location, or object, as well as defining the information type 770 such as general trivia, geographical, biographical, historical, numerical, dates/date ranges, medical, botanical, scientific, or any combination of categories that adequately provides context for that video, video scene, or video scene element. The system will use all user-generated data (along with auto-extracted video metadata) to refine and prioritize records in the visual media database 520 during the search and retrieval process to produce the semantically relevant search results. Additionally, the system database would employ natural language processing technologies to support semantic search and information retrieval.

As shown in FIG. 12, in addition to defining metadata and supplemental information for video scenes, the system's image-tagging toolset 1300 would allow users to fine-tune their entries by targeting elements within video still images 550 by defining “hotspots” 1210 (i.e., clickable regions within an image) within the still image 550 such as actors or objects. The aforementioned wiki-based template 1320 would allow data entry for all metadata, supplemental details, and categorical data relevant to that video scene element.

In another embodiment of this system, the database 520 would be programmed with a series of filters that act as approval monitors, such as an ontology or taxonomy of reference keywords that verify whether or not user-contributed content is appropriate for the general public. Additionally, for any URL addresses added as metadata or supplemental content for videos or video scenes, the system would have a verifying engine to validate the hyperlink addresses for accuracy and security.

One embodiment of the system may include the system wiki-based image-tagging toolset 1300 as part of the system client software 160 to enable users to contribute data to the system database 520 from outside the system website 530. In this embodiment (as shown in FIG. 12), users could include their supplemental data 700 as part of the data packet 1110 (along with the video still image 550 and system-extracted video metadata 800) submitted to the system to comprise a search query.

Another embodiment allows users on the system website 530 to search for video media content to retrieve video still images 550 and related data previously submitted by themselves or other users, and add or edit video-related information 700 to those existing entries using the system's wiki-based toolset 1300.

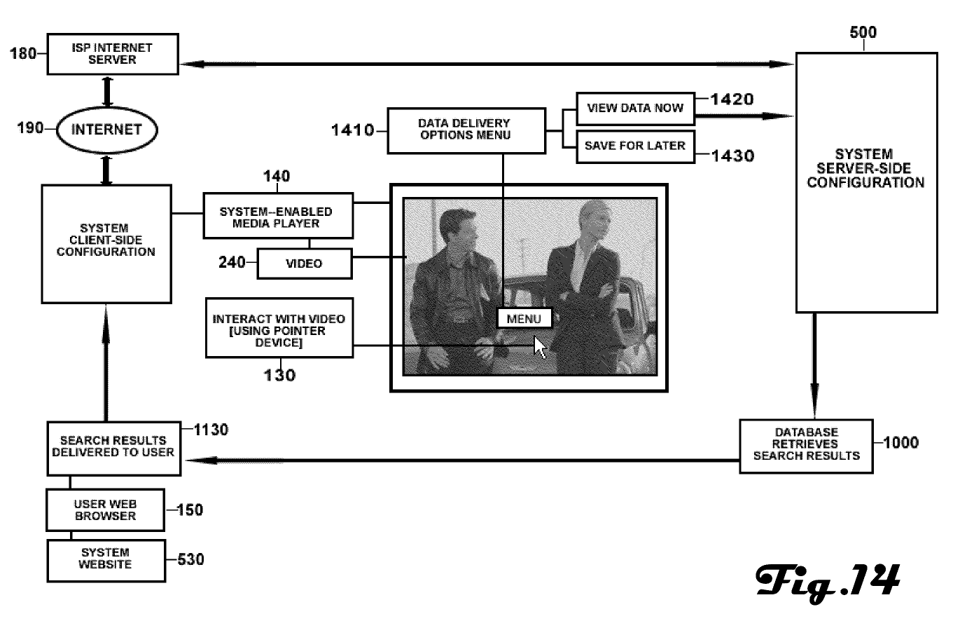

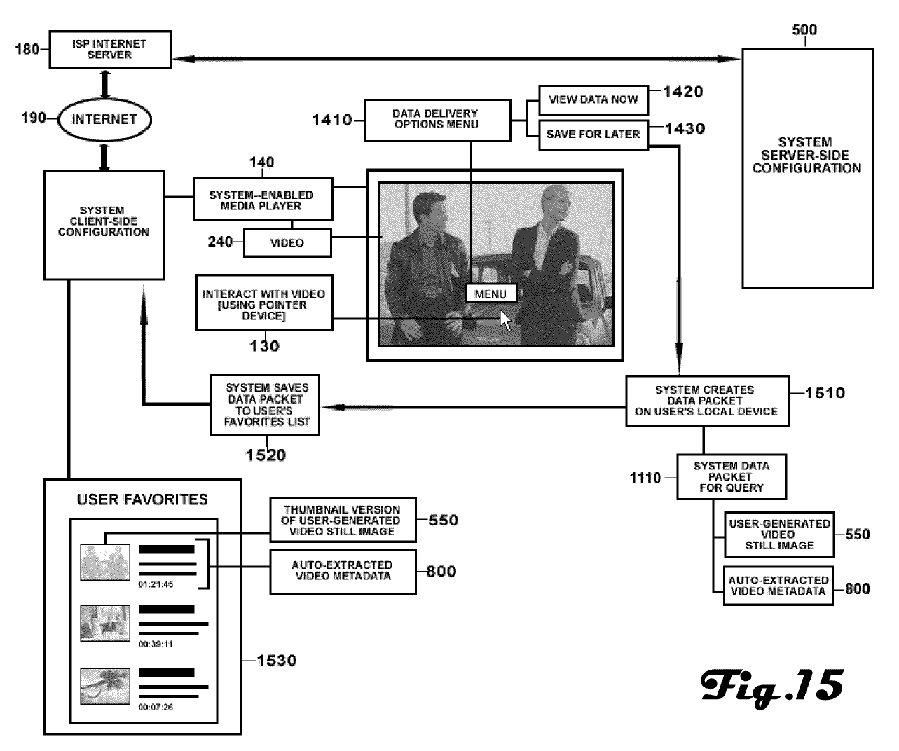

In a further embodiment of this system (as shown in FIGS. 14 and 15), information retrieval for video-related information can be either instantaneous or deferred by the user. When the user on the client-side configuration of the system 100 interacts with video content (using any form of pointing device 170), the video display pauses temporarily, and an options menu 1410 is displayed. The options menu 1410 enables the user to choose whether they want to view the video-related information immediately 1420 or save it for later viewing 1430.

In another embodiment, users could set preferences in their user profile 570 to inform the system to perform in one of the following ways: pause playback and show the options menu 1410; pause playback and automatically save each user-generated video screenshot image 550 to the user's local cached list 1530 for later use; or pause playback and automatically submit each user-generated video screenshot image 550 to the system servers 510 and database 520 for search and information retrieval. These user preferences could be set in various ways including (but not limited to): apply to the current viewing session; apply to all viewing sessions (until reset by the user); apply for a designated time-span established by a date range or other time setting; apply based on types of video media (e.g., short duration video vs. full-length feature films).

As shown in FIG. 14, one embodiment of this playback/information access scenario assumes the user chooses to view information immediately, in which case the system instantly bundles the cached user-generated video still image 550 and the auto-extracted video metadata 800 into a copyright-independent data packet 1110, and the user opts to submit the data packet 1110 to the system web servers 510 and database 520 as a search query for processing and information retrieval. Search results 1000 will be delivered via the system website 530, which opens as a separate web browser window 150 on the user's local device. With related educational and consumer information accessible to the user alongside the video display, information remains directly in context with what is being viewed in the video at any given time.

As shown in FIG. 15, another embodiment of this playback/information access scenario assumes the user wishes to defer access of the video-related information until a later time, in which case the system saves the cached user-generated video still image 550 and the related auto-extracted video metadata 800 in a bundled data packet 1110 to the user “favorites” list 1530, a cached folder (or other data repository) on the user's local device, much like users “bookmark” web pages. The user can later review their favorites list 1530 (via the system plug-in software or on the system website) and select any video-related data packet 1110 and submit it to the system servers 510 and database 530 as a search query to access related information.

In a further embodiment of this system, the database 520 assigns unique identifiers to all user-generated content 700 (video metadata and supplemental content), and assigns unique identifiers to all user-generated video still images 550 and system-extracted video metadata 800. In this way, each element related to a given video or video scene can be searched by users, including (but not limited to): query by video name 610 (i.e., find all content relating to specific video); query by actor name 620 (i.e., find all video-related content that includes a specific actor) or role (i.e., find all video-related content that references a specific role/character); query by object name or type 630 (e.g., find all video-related content that includes a specific make and model of vehicle); query by video scene location 640 (e.g., find all video-related content that references scenes in Venice, Italy); query by video time-stamp or data range 670; query by user name/wiki-editor name 650 (i.e., find all video-related content contributed by a specific user for a specific video or all videos known to the system); query by audio name or artist 660 (e.g., find all video-related content that includes music by a specific artist); query by data type 680; and query by scene event type 690 (e.g., find all video-related content that includes weddings). The system would also include search capabilities for queries related to closed captioning and subtitle information.

Another embodiment of the system search capabilities 600 would enable users to query the database 520 to locate all other user-generated wiki-entered text 710 for a given video, video scene, or video element so that metadata and/or informational content can be repurposed for a similar use (for example, descriptive content about storyline, actors, locations, objects, etc.). This feature would help to eliminate duplication and/or reinvention of content and promote consistency across the system database for identical or highly similar elements relevant to multiple videos, video scenes, or video elements, including (but not limited to): storylines, actors, roles, locations, events, objects, fashion, vehicles, and music. For example, a user intending to add new content about a given topic, such as trivia about a specific actor, could first query the database 520 to learn whether any information segments already exist about that actor. If the system locates related instances, the user could add them to the data related to their currently selected video still image 550. One embodiment would dictate that if the information segment originated outside the system (such as licensed from an external source), the user could not edit that information segment (or not do so without approval); if it originated within this system, the user could edit that information segment.

In another embodiment of the system's search functionality 600, the database 520 uses the auto-extracted time-stamp 850 of each user-generated video still image 550 to track the image's relevant placement in the overall video. Users could search based on time-stamps or time-spans 670 to find information and images related to a specific time reference in a given video. This function enables users to access all data available for any element in any scene that takes place during a specified time-span in a given video. For example, a user watching a film about World War One flying aces might want to find all available information relevant to specific “dogfight” scenes, such as the historical context, dates, location, objects such as planes and artillery, real life people involved, actors portraying those people in the film, other videos that reference the same battle scenes, and so on.

Another embodiment for the system's search functionality 600 would allow users to search for all video content of a specific data type 770, such as historical, biographical, statistical, or date-related information that may have been added as supplemental data for video still image screenshots 550 added to the system. For example, a user viewing the film “The Time Machine” might want to find all information about that video that cites specific dates or date ranges to get an overview of all the various timeframes referenced in the film. Using this example, a user could create a more complex query that includes date references and locations, to find information on all the timeframes referenced in the film and the related locations the characters visit across time.

In a further embodiment of the system search functionality 600, the system could continually be extended to include other search criteria as the database 520 becomes populated with numerous similar entries across numerous video references. For example, if multiple video entries exist in the database 520 that reference specific fashion designers (i.e., users recognized the designer apparel in scenes from films or television programs that were submitted to the system), the system could be extended to include search support based on popular criteria (e.g., find all video content that includes fashion by the designer Giorgio Armani).

An additional embodiment of the system includes Ad Server technology 540 that will assess video-related content retrieved by the system database 520 for a given search query, cross-reference that data with the user account 560 and user profile 570, and then process and deliver appropriate advertising 580 that is contextually relevant to that video-related content and user. The Ad Server 540 will be programmed to prioritize contextual advertising 580 based on a number of variables including (but not limited to): auto-extracted video metadata 800; user-generated video data 700; user profile data 570 such as demographics including location, gender, and age; highest paying sponsor ads; behavioral targeting such as user click-through and purchase history; and other variables common to this technology. The Ad Server 540 would support local advertising from a single publisher and third-party advertising from multiple publishers.

An additional embodiment of the system user account 560 would allow users to define demographic data such as age, gender, marital status, and other similar data. The system would then cross-reference the user account 560 and user profile 570 with the current search criteria to deliver relevant contextual advertising 580 alongside search results. For example, a user located in San Francisco could click a video scene that includes a stylish flat panel TV screen, and retrieve supplemental information about that product such as product overview, technical specs, and price range, as well as hyperlinks to purchase points in the Bay Area. Similarly, the system would track demographic data to deliver age- and gender-appropriate advertising 580 along with search results. For example, viewers of any age or gender interacting with video scenes in a Harry Potter film would likely see contextual ads 580 for DVDs and books related to the Potter series. However, a 12-year old female user might also respond well to ads 580 for products commonly enjoyed by people of her age range, such as games, costumes, and gadgets related to the film series; whereas a 35-year old male might respond better to ads for products or experiences more likely to appeal to adults, such as travel tours through medieval towns in England.

Another embodiment for contextual advertising 580 addresses the scenario in which users visit and search the system website 530 without having a user account 560 or the system client software 160. In this case, as no user profile data 570 is available, the system would detect user location based upon the accessing computer's Internet Protocol (IP) address, a data trail that is now commonly traceable down to the computer user's city. The system would then deliver search results with contextual advertising 580 relevant to the user's location, if applicable.

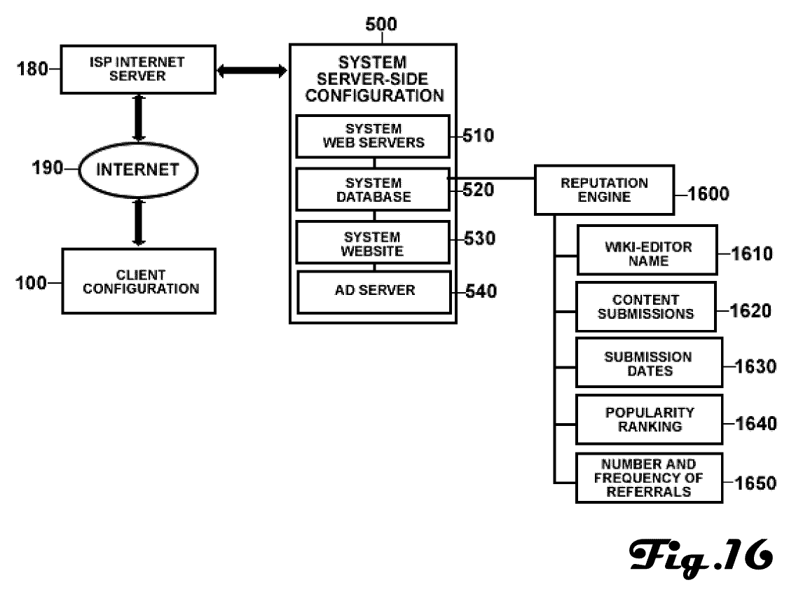

As shown in FIG. 16, an additional embodiment of this system designed to promote credibility and accuracy in user-generated content contributed through the system client software 160 and/or system website 530 would include a server-based reputation engine 1600. This engine 1600 would track user-generated content 700 with variables such as user/editor name 1610; content submissions 1620, submission dates 1630; popularity ranking 1640 based on user reviews and votes; referral count and frequency 1650 (i.e., number of times this editor's content has been shared via the referral tool 920; and other variables. The reputation engine 1600 would support collaborative community features 900 on the system website 530 that allow users to review user-generated video-related content 700 submitted by other users via the system's wiki-based toolset 1300, and rank that content in terms of accuracy and interest. In turn, the reputation engine 1600 would track reviews and ranking to prioritize users who submit content to the system, allowing opportunities for rewards, such as monetary compensation for high performing and/or popular contributors.

1. Systems and methods for enhanced interactive video system for integrating data for on-demand-information retrieval and internet delivery as shown and described.
